(19) United States
(12) Patent Application Publication
(10) Pub. No.: US 2016/0046153 A1
(43) Pub. Date: Feb. 18, 2016

(54) NON-PNEUMATIC WHEEL HAVING AN IMPROVED CUSHIONING EFFECT

(71) Applicant: HWA YALE YOO, Incheon (KR)

(72) Inventor: HWA YALE YOO, Incheon (KR)

(21) Appl. No.: 14/690,492

(22) Filed: Apr. 20, 2015

(30) Foreign Application Priority Data
Aug. 12, 2014 (KR) 10-2014-0104671

(51) Int. Cl. B60C 7/10

(52) U.S. Cl. CPC B60C 7/10

(57) ABSTRACT

The present invention relates to a non-pneumatic wheel having an improved cushioning effect by separating an inner ring and an outer ring of the non-pneumatic wheel. In addition, the present invention relates to a non-pneumatic wheel having an improved cushioning effect by increasing a tension of the outer ring occurred by the inner ring when the outer ring and the inner ring are coupled and concurrently limiting an expansion of the outer ring. The non-pneumatic wheel comprises an outer ring having a number of coupling portions of protruding shape formed in an inner side; a spoke portion integrally formed in an outer side; and an expansion preventing portion formed on an upper portion of the spoke and tightly fitted between a coupling portions of the outer ring.

### FIELD OF THE INVENTION

The present invention relates to a non-pneumatic wheel having an improved cushioning effect by separating an inner ring and an outer ring of the non-pneumatic wheel. In addition, the present invention relates to a non-pneumatic wheel having an improved cushioning effect by increasing a tension of the outer ring occurred by the inner ring when the outer ring and the inner ring are coupled and concurrently limiting an expansion of the outer ring. More particularly, the present invention relates to a non-pneumatic wheel having an improved durability by dispersing a load of wheel in the circumferential direction.

### DESCRIPTION OF THE RELATED ART

In general, the non-pneumatic wheel is a novel wheel using a spoke instead of an air, which is able to substitute a conventional wheel or tire requiring an air. The non-pneumatic wheel does not need a compressed air, therefore an air-pressure drop or blowout of the wheel during driving on the way is prevented.

In addition, the structure of the non-pneumatic wheel is very simple compared to the conventional wheel or tire and requires fewer materials than the conventional wheel. Accordingly, it is suitable to use it in extreme environment like a space environment, and recently many researchers take an active interest in this field and actively is studying to the non-pneumatic wheel.

A non-pneumatic tire is disclosed in KR Patent 10-1032001. As shown in FIG. 1, a spoke cushioning element (30) is extended towards a rotating axis supporting member (20) and has a plurality of protrusions (31a, 31b, 32a, 32b). The spoke cushioning element (30) is positioned between a radial partitions (31, 32) and links a radial partitions (31, 32) each other. Protrusions (31a, 31b, 32a, 32b) are formed between the radial partitions (31, 32) and form an auxetic structure having a plurality of space through a linking partitions (33, 34) which link between two points having an opposite direction each other, and also link a ground contact portion (10) and the rotating axis supporting member (20).

According to the conventional art, the protrusions (31a, 31b, 32a, 32b) and the linking partitions (33, 34) are integrally formed and the tire is deformed by a pressure or impact so as to perform a function of tire. When the pressure or impact are removed, the tire is restored to the original state. However, because the linking partitions (33, 34) are integrally formed with the radial partitions (31, 32) and a fatigue of tire due to a repeated alternating stress occurred by the linking partitions (33, 34), a durability of tire is not good.

In addition, the structure of the conventional tire disclosed in KR Patent 10-1032001 is very complicated, and thus it is difficult to manufacture it and the manufacturing cost is to be increased. Because of the integrated form of the link partitions (33, 34) and the radial partitions (31, 32), the conventional tire is also limited in the use of it.

### SUMMARY OF THE INVENTION

It is an object of the present invention is to provide an improved non-pneumatic wheel having a simple structure which is easy to be manufactured and a strong coherence of the outer ring and the inner ring by means of a separation preventing and a stopping portion formed on the outer ring and the inner ring, respectively.

It is another object of the present invention is to provide an improved wheel having an improved cushioning effect by means of an expansion preventing portion formed on the inner ring and a function dispersing a load of wheel in the circumferential direction.

It is yet another of the present invention is to provide an enhanced cushioning effect having an initial tension occurred by tight fitting the outer ring and the inner ring and at the same time a space formed between the outer ring and the inner ring which act like a spring.

To achieve the above described objects, the present invention is characterized by a non-pneumatic wheel comprising an outer ring having a number of coupling portions of protruding shape formed in an inner side; a spoke portion integrally formed in an outer side; an expansion preventing portion formed on an upper portion of the spoke and tightly fitted between a coupling portion of the outer ring.

The coupling portion of the outer ring comprises a first vertical portion vertically formed from the inner side of the outer ring; and a first horizontal portion formed at an end of the first vertical portion. The expansion of the inner ring comprises a second vertical portion vertically formed from the outer side of the spoke; and a second horizontal portion formed at an end of the second vertical portion.

The width of the second horizontal portion is the same as the distance of a gap of the neighboring first vertical portion.

The width of the second vertical portion is the same as the distance of a gap of the neighboring first horizontal portion.

In addition, the separation preventing stopping portion is formed on the inner side of the first horizontal portion, the stopping portion is formed on the inner side of the second horizontal portion which is coupled to the separation preventing stopping portion.

The separation preventing stopping portion comprises a first separation preventing stopping portion and a second separation preventing stopping portion which are symmetrically positioned each other at the right side and the left side on the first vertical portion. The stopping portion comprises a first stopping portion and a second stopping portion which are symmetrically positioned each other at the right side and the left side on the second vertical portion.

In addition, a first slope and a second slope are formed on the outside end of the first and second separation preventing stopping portion and the first and second stopping portion, respectively.

The expansion of the inner ring is coupled between the link portions of the outer ring by tight fitting.

A first space is formed between the inner side of the outer ring and the outer side of the expansion preventing portion.

In addition, a second space is formed between the inner side of the link portions of the outer ring and the outer side of the spoke.

According to the present invention, a cushioning effect of wheel is improved by limiting a lateral expansion of the outer ring by means of the expansion preventing portion formed on the inner ring and at the same time the durability of wheel is also improved by dispersing a load in the circumferential direction.

According to the present invention, the structure of the non-pneumatic wheel is very simple by separating the outer ring and the inner ring, and thus it is easy to manufacture the non-pneumatic wheel. Additionally, the non-pneumatic wheel is able to maintain a binding force of the outer ring and the inner ring by means of the separation preventing stopping portion and the stopping portion which are formed on the outer ring and the inner ring, respectively.

In addition, according to the present invention, the non-pneumatic wheel has an enhanced cushioning effect having an initial tension occurred by tight fitting the outer ring and the inner ring and at the same time the space formed between the outer ring and the inner ring which act like a spring.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a front view showing a conventional non-pneumatic tire.

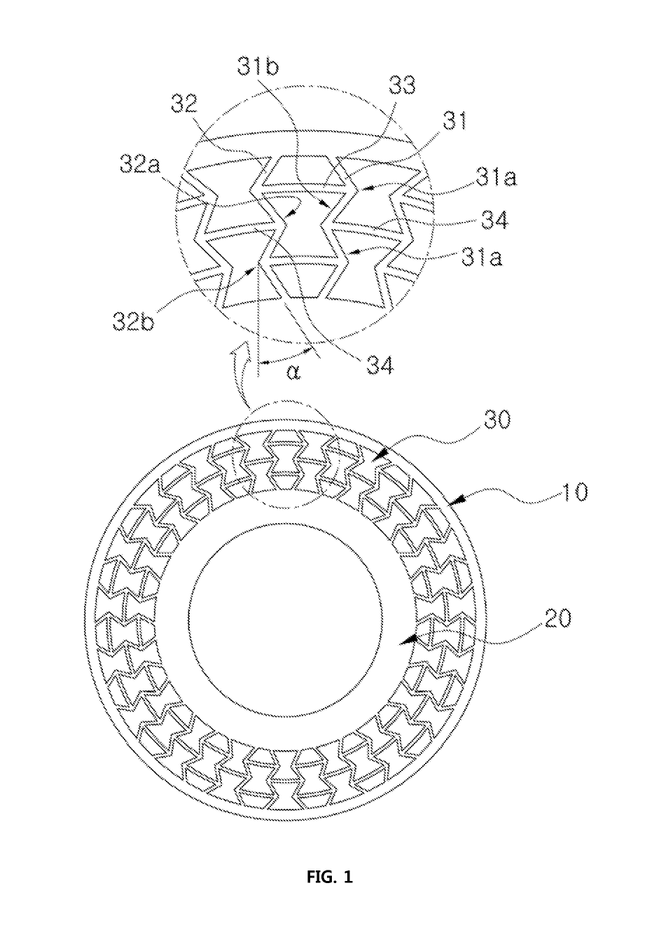

FIG. 2 is a front view showing an embodiment of the non-pneumatic wheel according to the present invention.

FIG. 3 is a separate perspective view showing the non-pneumatic wheel of FIG. 2.

FIG. 4 is a partially enlarged view showing in detail a part of the outer ring of the present invention.

FIG. 5 is a partially enlarged view showing in detail a part of the inner ring of the present invention.

FIG. 6 is a perspective view showing another embodiment of the non-pneumatic wheel according to the present invention.

### DETAILED DESCRIPTION

Reference will now be made in detail to embodiments of the present invention, examples of which are illustrated in the accompanying drawings, wherein like reference numerals refer to like elements throughout. The embodiments are described below in order to explain the aspects of embodiments of the present invention by referring to the figures.

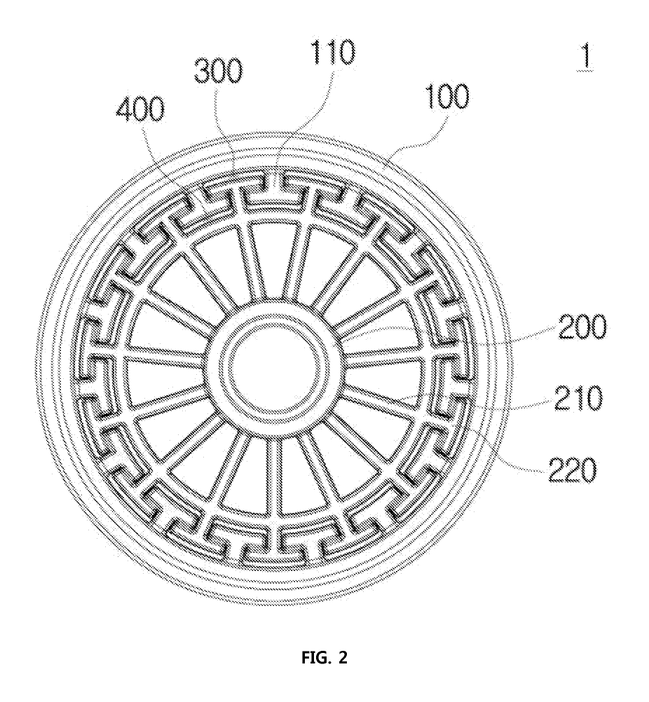

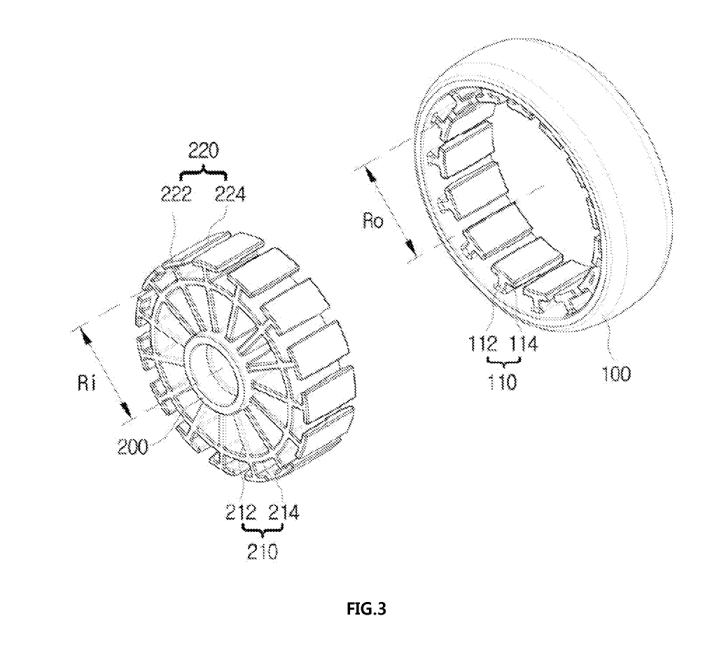

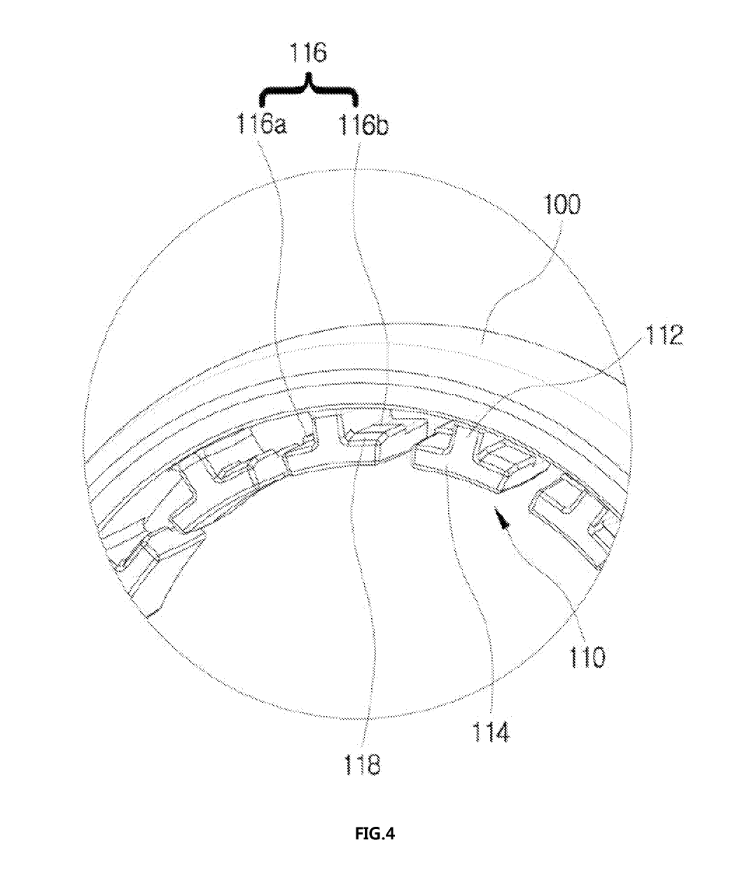

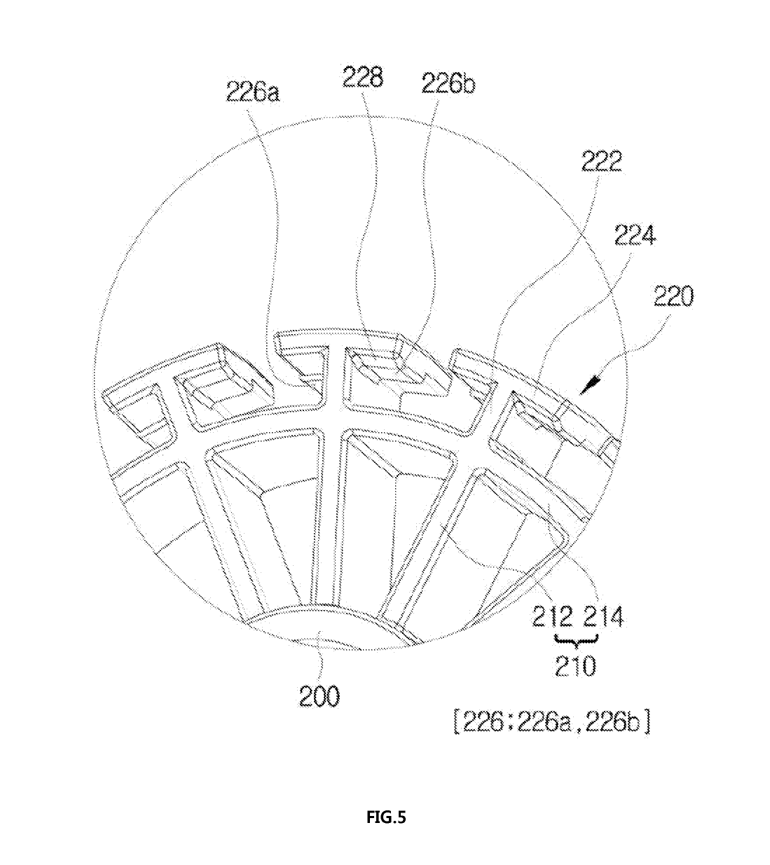

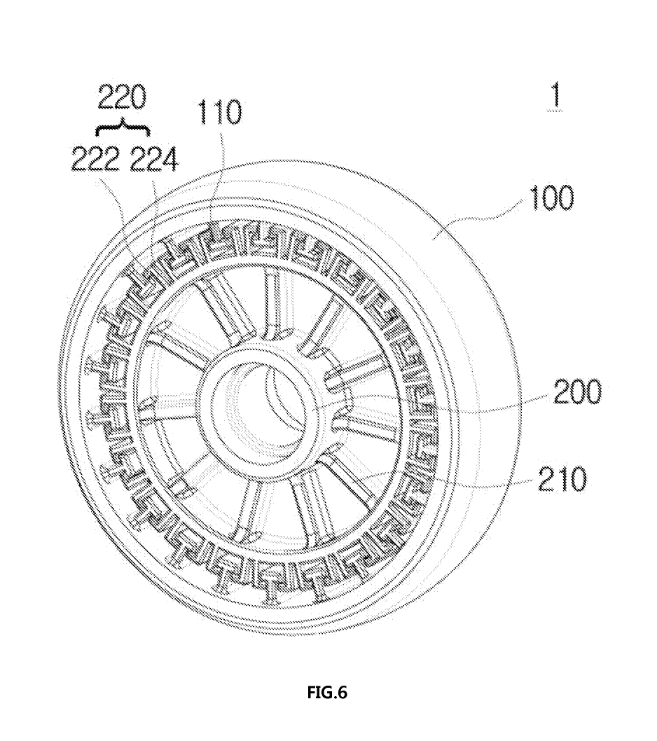

FIG. 2 is a front view showing an embodiment of the non-pneumatic wheel according to the present invention, FIG. 3 is a separate perspective view showing the non-pneumatic wheel of FIG. 2, FIG. 4 is a partially enlarged view showing in detail a part of the outer ring of the present invention, FIG. 5 is a partially enlarged view showing in detail a part of the inner ring of the present invention, and FIG. 6 is a perspective view showing another embodiment of the non-pneumatic wheel according to the present invention.

The present invention relates to a non-pneumatic wheel (1) having an improved cushioning effect by separating an outer ring (100) and an inner ring (200) of the non-pneumatic wheel (1). In addition, the present invention relates to a non-pneumatic wheel (1) having an improved cushioning effect by increasing a tension of the outer ring (100) occurred by the inner ring (200) when the outer ring (100) and the inner ring (200) are coupled and concurrently limiting an expansion of the outer ring (100). More particularly, the present invention relates to a non-pneumatic wheel (1) having an improved durability by dispersing a load of wheel in the circumferential direction.

More specifically, the outer ring (100) contacts with a ground and has a cylindrical shape having an even thickness and width.

A plurality of link portions (110) of a protruding shape are formed on the inner side of the outer ring (100). The inner ring (200) may be coupled with the inner side of the outer ring (100) by allowing an expansion preventing portion (200) of the inner ring (200) to be inserted into the link portions (100).

That is, the non-pneumatic wheel (1) of the present invention is different from the conventional wheel that the outer ring (100) and the inner ring (200) are integrally formed. The non-pneumatic wheel (1) of the present invention is to be made by coupling the outer ring (100) with the inner ring (200), and thus has more simple than the conventional wheel and is able to easily make it. Accordingly, it is also possible to reduce a manufacturing costs and defect rate.

Next, the inner ring (200) is concentrically formed on the inner side of the inner ring (200), and the inner ring (200) has a cylindrical shape having an even thickness and width like the outer ring (100). A rotating axis (not shown) is inserted into the inner ring (200).

In addition, the spoke portion (210) and the expansion preventing portion (220) is integrally formed on the outer side of the inner ring (200), and the spoke portion (210) is integrally formed on the outer side of the inner ring (200) and has a role to reduce an impact applied to the non-pneumatic wheel (1) during driving on the way. The spoke portion (210) is formed with a plurality of vertical members (212) and a circular member (214). The plurality of vertical members (212) have a protruding shape towards the vertical direction and one end of the plurality of vertical members (212) contacts with the outer side of the inner ring (200). The circular member (214) connects another end of the plurality of vertical members (200) and is formed with the inner ring (200) and a concentric circle.

Next, the expansion preventing portion (220) is integrally formed on the circular member (214) of spoke portion (210), that is, the outer side, and thus the expansion preventing portion (220) is tightly fitted between the link portions formed on the outer ring (100) to couple the inner ring (200) to the inner side of the outer ring (200).

According to the detailed description of the relationship between the link portion (110) of the outer ring (100) and the expansion preventing portion (220) of the inner ring (200), the link portion (110) is comprised of a first protruding vertical part (112) vertically formed from the inner side of the outer ring (100), a first horizontal portion (114) horizontally formed at an end of the first vertical portion (112), that is, the outer ring (100). Accordingly, the link portion (110) generally has a ‘⊥’ shape to the upper portion of the non-pneumatic wheel (1).

In addition, the expansion preventing portion (220) of the inner ring (200) has a shape which is rotated by 180° against the link portion (110) of the outer ring (100) and is tightly fitted into the space formed between the link portions (110). The expansion preventing portion (220) of the inner ring (200) is comprised of a second protruding vertical part (222) vertically formed from the outer side of the spoke portion (210) of the inner ring (200), a second horizontal portion (224) horizontally formed at an end of the second vertical portion (222). Accordingly, the expansion preventing portion (220) of the inner ring (200) generally has a ‘T’ shape to the upper portion of the non-pneumatic wheel (1).

The width distance of the second horizontal portion (224) is formed at the same distance as the distance of the first vertical portion (112) of a neighboring link portion (110). Accordingly, when the expansion preventing portion (220) is tightly fitted into the gap of the link portion (110), the both sides of the second horizontal portion (224) are formed to support the sides of the neighboring first vertical portion (112).

In addition, the width distance of the second vertical portion (222) is formed at the same distance as the distance of the first horizontal portion (114) of a neighboring link portion (110). Accordingly, when the expansion preventing portion (220) is tightly fitted into the gap of the link portion (110), the both sides of the first horizontal portion (114) are formed to support the sides of the neighboring first horizontal portion (114).

In other words, the expansion preventing portion (220) is formed with the second vertical portion (222) and the second horizontal portion (224) and the expansion preventing portion (220) limits an expansion of the outer ring (100) against the direction perpendicular to the lateral direction, that is, the direction perpendicular to the applied load when the load is applied to the non-pneumatic wheel (1). Accordingly, the cushioning effect of the non-pneumatic wheel (1) will be improved by limiting an expansion of the outer ring (100).

More specifically, when a force is vertically applied to the outer ring (100) against the ground, a height of the non-pneumatic wheel is reduced due to a compressive force. Accordingly, the width of the non-pneumatic wheel (1) is deformed in the widthwise direction. However, the deformation of the outer ring (100) is limited in the widthwise direction by the gap of the link portion (110) of the outer ring (100), that is, the vertical portion (222) and the horizontal portion (224) of the expansion preventing portion (220) supporting the side of the first horizontal portion (114) and the vertical portion (112), and thus the compressive force of the outer ring (100) acts as a compressive force of the non-pneumatic wheel and consequently the cushioning effect of the non-pneumatic wheel is to be improved.

According to the function of the expansion preventing portion (220), the force widthwise applied to the non-pneumatic wheel (1) is dispersed to the circumferential direction through the expansion preventing portion (220) and the spoke portion (210), and thus all of the non-pneumatic wheel (10) play the role of the spring, since the elastic range occurred in the non-pneumatic wheel is more broadly formed.

In addition, the dispersion force means that a driving force of the non-pneumatic wheel (1) is dispersed in the vertical direction, that is, in the circumferential direction, and thus also means that the driving resistance occurred during driving of the non-pneumatic wheel is to be reduced.

Meanwhile, the expansion preventing portion (220) of the inner ring (200) is tightly fitted into the gap of the link portion (110) of the outer ring (100), and thus the cushioning effect of the non-pneumatic wheel (1) is to be improved by a tension applying to the outer ring (100).

More specifically, the distance (Rᵢ) from the center of the non-pneumatic wheel (1) to the inner side of the second horizontal portion (224) of the expansion preventing portion (220) is more shorter than the distance (Rₒ) from the center of the non-pneumatic wheel (1) to the inner side of the first horizontal portion (114) of the link portion (110) and the expansion preventing portion (220) of the inner ring (200) is tightly fitted into the gap of the link portion (110) of the outer ring (100). When the inner ring (200) is inserted into the inner side of the outer ring (100) by tight fitting, the outer ring after inserting the inner ring (200) generally maintains more compressive state than the outer ring (100) before inserting the inner ring (200). Accordingly, the cushioning effect of the non-pneumatic wheel is to be improved.

Although there is a distance difference between the distance (Rᵢ) from the center of the non-pneumatic wheel (1) to the inner side of the second horizontal portion (224) of the expansion preventing portion (220) and the distance (Rₒ) from the center of the non-pneumatic wheel (1) to the inner side of the first horizontal portion (114) of the link portion (110), it is possible to insert the outer ring (100) into the inner ring (200), since the outer ring (100) is made of elastic material. Accordingly, as described in the below, it is able to easily couple the outer ring (100) with the inner ring (200) by a first plane and a second plane (118, 228) formed on the link portion (100) and the inner ring (200) of the outer ring (100), respectively.

Meanwhile, because the outer ring (100) and the inner ring (200) are coupled by tight fitting each other, a separation of the outer ring (100) and the inner ring (100) is somewhat prevented. However, so as to maintain more strong binding force, a separation stopping portion (116) and a stopping portion (226) are formed in the outer ring (100) and the inner ring (200), respectively.

In other words, as shown in FIG. 4, the separation stopping portion (116) is formed on the inner side of the first horizontal portion (114) which is comprised of the link portion (110) of the outer ring (100), and as shown in FIG. 5, so as to prevent a separation of the outer ring (100) and the inner ring (100) during driving of the non-pneumatic wheel (1), the stopping portion (226) which is coupled to the separation stopping portion (116) is formed on the inner side of the second horizontal portion (224) which is comprised of the expansion preventing portion (220) of the inner ring (200).

More specifically, the separation stopping portion (116) is comprised of a first separation stopping portion (116a) and a second separation stopping portion (116b) which are formed on the inner side of the first horizontal portion (114) positioned in the right side and the left side on the first vertical portion (112) of the link portion (110), and the first separation stopping portion (116a) and the second separation stopping portion (116b) are oppositely positioned each other, that is, are symmetrically formed on the first vertical portion (112).

In addition, the stopping portion (226) is comprised of a first stopping portion (226a) and a second stopping portion (226b) which are formed on the inner side of the second horizontal portion (224) positioned in the right side and the left side on the second vertical portion (222) of the expansion preventing portion (220), and the first stopping portion (226a) and the second stopping portion (226b) are oppositely positioned each other, that is, are symmetrically formed on the first vertical portion (222) each other.

The first and second separation stopping portions (116a, 116b) and the first and second stopping portions (226a, 226b) are crossed each other, and thus the first and second separation stopping portions (116a, 116b) are coupled to the first and second stopping portions (226a, 226b) by locking structure.

In other words, as described in the above, because the first and second separation stopping portions (116a, 116b) are symmetrically formed on the vertical portion (112) of the link portion (110), the first and second separation stopping portions (116a, 116b) and the first and second stopping portions (226a, 226b) are crossed each other, and because of the interaction of the first and second separation stopping portions (116a, 116b) and the first and second stopping portions (226a, 226b), the expansion preventing portion (220) of the inner ring (200) is not moved during driving of the non-pneumatic wheel (1) in case of tightly fitting the expansion preventing portion (220) of the inner ring (200) into the gap of the link portion (110) of the inner ring (100), the couple of the outer ring (200) and the inner ring (100) are strongly maintained.

In addition, as shown in FIG. 4 and FIG. 5, the first slope (118) having a slope downwards the outer side direction is formed at the outside end of the first and second separation stopping portions (116a, 116b) on the upper of the non-pneumatic wheel (1), and the second slope (118) having a slope upwards the outer side direction is formed at the outside end of the first and second stopping portions (226a, 226b) on the upper of the non-pneumatic wheel (1), and the first and second slopes (118, 228) play a role as a guide to couple the link portion (110) with the expansion preventing portion (220).

In other words, as described in the above, the link portion (110) and the expansion preventing portion (220) are coupled by tight fitting. The tight fitting is easily done by forming the first slope (118) and the second slope (228) in the link portion (110) and the expansion preventing portion (220), respectively.

Meanwhile, as shown FIG. 2, a first space (300) is formed between the inner side of the outer ring (100) and the outer side of the expansion preventing portion (220) of the inner ring (200), and the cushioning effect of the non-pneumatic wheel (1) is improved by allowing a first space (300) to shrink the outer ring (100) along to the direction that a force is applied to the outer ring (100).

As described in the above, because the expansion preventing portion (220) of the inner ring (200) vertically limits an expansion to the direction that a force is applying, the expansion preventing portion (220) is allowed to shrink along the direction that a force is applied, and thus the cushioning effect is to be improved by means of a force which is limited by the expansion preventing portion (220) and at the same time the force applied to the non-pneumatic wheel (1) is circumferentially dispersed along the expansion preventing portion (220) and the spoke portion (210).

As shown in FIG. 2, the cushioning effect is to be improved by forming a second space (400) between the inner side of the link portion (110) of the outer ring (100) and the outer side of the spoke portion (210) of the inner side (200), and the dispersion effect of force also is to be improved.

As shown in FIG. 6, according to the non-pneumatic wheel (1), the second vertical portion (222) of the expansion preventing portion (220) formed in the inner ring (200) is able to be separated into the two portion, in this case it is more easy to insert the expansion preventing portion (220) into the link portion (110) of the inner ring (100), and because the width of the second vertical portion (222) is more thickening, the limiting effect which is vertically expanded in the direction perpendicular to the force applied direction also is to be improved.

Accordingly, as described in the above, according to the non-pneumatic wheel (1) of the present invention, the cushioning effect of the non-pneumatic wheel (1) is improved by limiting a lateral expansion of the outer ring (100) by means of the expansion preventing portion (220) formed in the inner ring (200) and at the same time the durability of the non-pneumatic wheel (1) is improved by circumferentially dispersing a load applied to the non-pneumatic wheel (1). In addition, it is easy to manufacture it by separating the outer ring (100) and the inner ring (200) and it is possible to strongly maintain a binding force of the outer ring (100) and the inner ring (200) by means of the separation stopping portion (116) and the stopping portion (226) formed on the outer ring (100) and the inner ring (200), respectively. The initial tension is given to the outer ring (100) by tight fitting the outer ring (100) and the inner ring (200) and at the same time forming the space in the link portion between the outer ring (100) and the inner ring (200), therefore, the cushioning effect of the non-pneumatic wheel (1) is to be improved by the outer ring (100) which generally act like a spring.

It is to be understood that the above description is illustrative of the present invention and is not to be construed as limiting the invention. Various modifications and applications may occur to those skilled in the art without departing from the true spirit and scope of the present invention as defined by the appended claims.

The present invention relates to a non-pneumatic wheel having an improved cushioning effect by separating an inner ring and an outer ring of the non-pneumatic wheel. In addition, the present invention relates to a non-pneumatic wheel having an improved cushioning effect by increasing a tension of the outer ring occurred by the inner ring when the outer ring and the inner ring are coupled and concurrently limiting an expansion of the outer ring. More particularly, the present invention relates to a non-pneumatic wheel having an improved durability by dispersing a load of wheel in the circumferential direction.

What is claimed is:

1. A non-pneumatic wheel, comprising:
an outer ring that a number of link portions are protruded on an inner side of the outer ring; and
an inner ring coupled in the inner side of the outer ring having a spoke portion integrally protruded on an outer side and an expansion preventing portion tightly fitted into a gap between the link portions of the outer ring formed on an upper of the spoke portion;
wherein the link portions of the outer ring are comprised of a first vertical portion which is vertically protruded from the inner side of the outer ring and a first horizontal portion which is formed at an end of the first vertical portion;
wherein the expansion preventing portion of the inner ring is comprised of a second vertical portion which is vertically protruded from the outer side of the spoke portion and a second horizontal portion which is formed at an end of the second vertical portion;
wherein a separation stopping portion is protruded on the inner side of the first horizontal portion, and a stopping portion coupled to the separation stopping portion is protruded on the inner side of the second horizontal portion.

2. The non-pneumatic wheel as claimed in claim 1,
wherein a distance of widthwise direction of the second horizontal portion is the same as a distance between the neighboring first vertical portions.

3. The non-pneumatic wheel as claimed in claim 1,
wherein a distance of widthwise direction of the second vertical portion is the same as a distance between the neighboring first horizontal portions.

4. The non-pneumatic wheel as claimed in claim 1,
wherein the separation stopping portion is comprised of the first and second separation stopping portions which are symmetrically formed each other in the right side and the left side on the first vertical portion, and the stopping portion is comprised of the first and second stopping portions which are symmetrically formed each other in the right side and the left side on the second vertical portion.

5. The non-pneumatic wheel as claimed in claim 4,
wherein a first slope and a second slope which act as a guide to couple the link portions with the expansion preventing portion are formed at the ends of the first and second stopping portions.

6. The non-pneumatic wheel as claimed in claim 1,
wherein the expansion preventing portion of the inner ring is tightly fitted into the gap of the link portions of the outer ring.

7. The non-pneumatic wheel as claimed in claim 1,
wherein a first space is formed between the inner side of the outer ring and the outer side of the expansion preventing portion of the inner ring.

8. The non-pneumatic wheel as claimed in claim 1,
wherein a second space is formed between the inner side of the link portion of the outer ring and the outer side of the spoke portion of the inner ring.
